(19) United States
(12) Patent Application Publication
(10) Pub. No.: US 2025/0299555 A1
(43) Pub. Date: Sep. 25, 2025

(54) COORDINATED REMINDER MOBILE APPLICATION

(71) Applicant: Chidimma Okoli, Worcester, MA (US)

(72) Inventor: Chidimma Okoli, Worcester, MA (US)

(21) Appl. No.: 19/085,476

(22) Filed: Mar. 20, 2025

Related U.S. Application Data
(60) Provisional application No. 63/567,516, filed on Mar. 20, 2024.

(51) Int. Cl. G08B 21/24

(52) U.S. Cl. CPC G08B 21/24

(57) ABSTRACT

A coordinated reminder mobile application system designed to enhance scheduling and notification systems, particularly for caregiver-dependent relationships. The system allows caregivers to create reminders for dependents without accessing their devices, generates notifications for both parties, and initiates follow-through requests to ensure task completion. The system is particularly useful for managing medication compliance, health monitoring, and medical appointments, thereby increasing accountability and compliance.

### CROSS-REFERENCE TO RELATED APPLICATIONS

This application claims benefit to Provisional Application No. 63/567,516, filed Mar. 20, 2024, the contents of which are herein incorporated by reference.

### BACKGROUND OF THE INVENTION

### Field of Endeavor

The present disclosure relates to reminder applications and, more particularly, to a reminder application for providing coordinated scheduling and reminders.

### Background of Related Art

Reminders, or notifications, can increase adherence to medical treatment, task accomplishment, and goal achievement. Ostensibly reminders provide an indication to act, and can be particularly important when dealing with life critical tasks such as medication compliance, health monitoring, medical appointments, etc. Traditional reminder applications typically require a user to setup their own reminders, and notifications are only provided to the user who set-up the reminders. These systems are disadvantageous, particularly, to a caregiver-dependent/ward relationship. Dependents/wards may live far away, be unable to use technology easily, or have memory/cognitive issues that make it difficult to take care of setting up their own reminders. Furthermore, caregivers are typically not included in the reminders, which can cause lack of compliance by the dependent, and anxiety for the caregiver.

As can be seen, there is a need for a scheduling system that provides ease of installation, coordinated scheduling, and coordinated notifications.

### SUMMARY OF THE INVENTION

In one embodiment, the disclosure provides a system that includes memory devices storing instructions and processors configured to execute those instructions to perform a method for creating and managing reminders. The method involves receiving a request to create a reminder, wherein the request comprises user information, temporal data, and additional reminder data. Based on this request, a reminder notification is generated and subsequently transmitted to a user device using the user information. The system further triggers the output of the reminder notification at the appropriate time based on the temporal data.

In another embodiment, the disclosure provides a computer-implemented method for health reminders. This method comprises receiving a request that contains user information, temporal data, and additional reminder data; creating a reminder notification from the request; transmitting the reminder notification to a user device based on the provided user information; triggering the output of the reminder notification according to the temporal data; and outputting the reminder notification to the user device.

In further embodiments, the method includes additional features for enhanced interaction. For example, in response to an interaction with the reminder notification, the system displays an additional notification on the user device, with the additional notification being presented based on the user information. Moreover, the user information may indicate whether the reminder is a personal reminder or a third-party reminder, wherein the reminder notification is transmitted to a first user device for personal reminders or to a second, distinct user device for third-party reminders. These and other features are described in greater detail in the following description and claims.

### BRIEF DESCRIPTION OF THE DRAWINGS

FIG. 1 is a block diagram of an embodiment of a reminder system, according to aspects of the present disclosure;

FIG. 2 is a flow diagram of a method for providing reminder notifications, according to aspects of the present disclosure;

FIG. 3 is a first User Interface of one or more reminders of the system, according to aspects of the present invention;

FIG. 4 is a User Interface of a first reminder entry, according to aspects of the present invention;

FIG. 5 is a User Interface of a second reminder entry, according to aspects of the present invention;

FIG. 6 is a second User Interface of one or more reminders of the system, according to aspects of the present invention;

FIG. 7 is a first User Interface of one or more notifications, according to aspects of the present invention; and

FIG. 8 is a second User Interface of one or more notifications, according to aspects of the present invention.

### DETAILED DESCRIPTION OF THE INVENTION

The following detailed description is of the best currently contemplated modes of carrying out exemplary embodiments of the disclosure. The description is not to be taken in a limiting sense but is made merely for the purpose of illustrating the general principles of the disclosure since the scope of the disclosure is best defined by the appended claims.

Current reminder notification applications require active participation from the user of the application with regard to installation, usage, and management. Furthermore, current reminder notification applications provide notifications only to the user of the application, which can decrease accountability and compliance. When reminders inform multiple people simultaneously, the reminder requires an invitation each time and for each notification, thereby requiring an email for each instance. The invited person also must accept the notification and create an event on their calendar.

Broadly, an embodiment of the present disclosure provides a system and method for coordinate reminder notifications that can allow 3^{rd} parties to aid a user with installation, usage, and management of reminders, while also allowing for notifications to be provided to a 3^{rd} party based on reminders that have been setup, thereby increasing accountability and compliance.

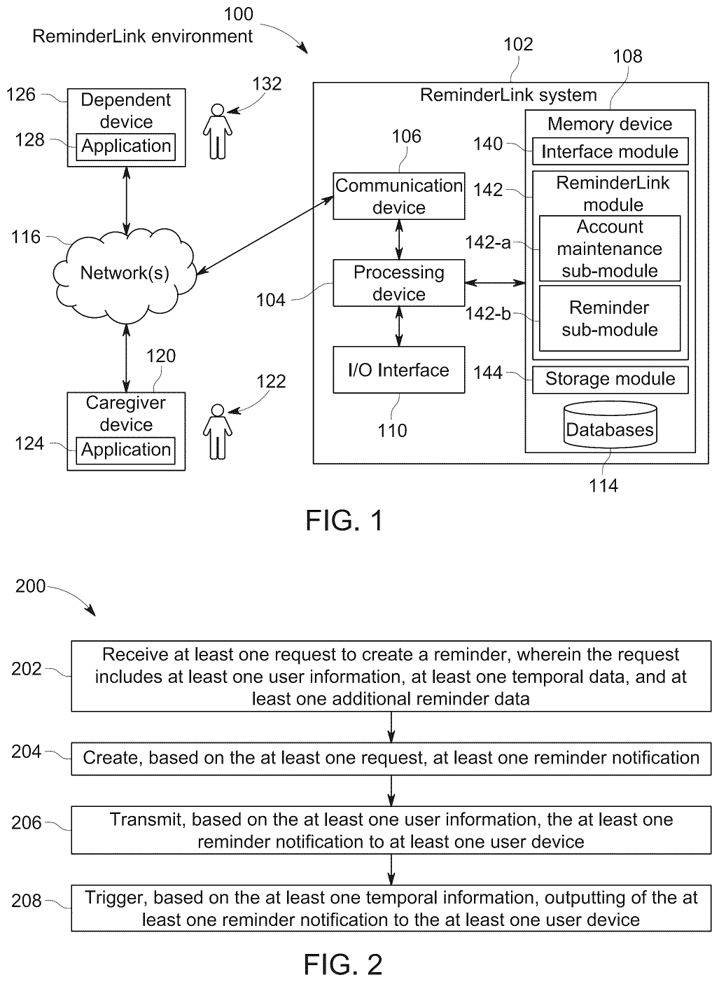

Referring now to FIG. 1, FIG. 1 illustrates an embodiment of a Reminder Environment 100, herein “ReminderLink”, according to aspects of the present disclosure. While FIG. 1 illustrates various components of the ReminderLink 100, additional components can be added, and existing components can be removed.

As illustrated in FIG. 1, the ReminderLink system 102 includes one or more processing devices, herein processing device 104, coupled to a communication device 106. The processing device 104 is also coupled to a memory device 108, and an input/output (“I/O”) interface 110. In embodiments, the communication interface 104 enables the ReminderLink system 102 to communicate with other devices and systems via one or more networks 116. The ReminderLink system 102 can communicate with a Caregiver device 120 and Dependent Device 126 via the network 116. A user 122 can utilize the caregiver device 120 to communicate with the ReminderLink system 102. The caregiver device 120 can include one or more electronic devices such as a laptop computer, a desktop computer, a tablet computer, a smartphone, a thin client, a smart appliance, and the like. A user 132 can utilize the dependent device 126 to communicate with the ReminderLink system 102. The dependent device 126 can include one or more electronic devices such as a laptop computer, a desktop computer, a tablet computer, a smartphone, a thin client, a smart appliance, and the like. While FIG. 1 illustrates one caregiver device 120 and one dependent device 126, the ReminderLink Environment 100 can include multiple user devices operated by the user 122, 132, or operated by other users.

According to the aspects of the present disclosure, the ReminderLink system 102 enables the user 122 and 132, operating a copy of an application 124 and 128 executing on the caregiver device 120 and dependent device 126, to communicate with the ReminderLink system 102 and leverage the service provided by the ReminderLink system 102. The ReminderLink system 102 is configured to allow a caregiver 122 to create reminders for the dependent 132 via this application 124 without having to have access to the application 128 on the dependent's device or adding it again on their own device; to generate notifications for the caregiver 122 at the same time that the dependent 132 gets notified of a reminder; and initiate follow-through requests that can alert the caregiver 122 if the action the dependent 132 is being reminded of has taken place or not.

To perform the process described herein, the ReminderLink system 102 can store and execute an Interface module 140, a ReminderLink module 140, and an Storage module 140 to perform the processes and methods described herein. The Interface module 140, the ReminderLink module 140, and the Storage module 140 can be stored in the memory device 108. The Interface module 140, the ReminderLink module 140, and the Storage module 140 can include the necessary logic, instructions, and/or programming to perform the processes and methods described in further detail below. The Interface module 140, the ReminderLink module 142, and the Storage module 144 can be written in any programming language.

According to aspects of the present disclosure, the ReminderLink system 102, for example, via the Interface module 140, provides unique interfaces that allow the user 122 and 132 to login, provide demographic information, provide validation/verification information, add/delete/update or otherwise manage reminders, display reminders and notifications, manage overall application settings, etc. The Interface module 140 operates to generate and provide graphical user interfaces (GUIs) to the applications 124 and/or 128, for example, menus, widgets, text, images, fields, etc., as described below in further detail. The GUIs generated by the Interface module 140 can be interactive. The ReminderLink system 102, for example, via the Interface module 140, also provide one or more application programming interface (APIs) that provide connection points for one or more application, e.g., the application 124 and 128.

In exemplary embodiments, the GUIs can include, but are not limited to, a Sign-in Interface, one or more Verification Interface(s), an Account Creation Interface, a Subscription Interface, one or more Notification Interface(s), one or more Reminder Interface(s), one or more Contact Interface(s), and/or one or more Settings Interface(s).

In exemplary embodiments, the Sign-in Interface can include a fillable user interface element for entering a unique identifier of a user, such as a phone number, an actuatable user interface element for executing a log-in procedure, and/or an actuatable user interface element for creating a new account, that when actuated executes an account creation procedure.

In exemplary embodiments, the one or more Verification Interface(s) can include at least a first interface having a message thereon, including an executable link, such as a hyperlink, URL, URI, etc., for providing additional login, or sign-in interfaces. The one or more Verification Interface(s) can include at least a second interface having at least one user interface element for entering a unique identifier of a user, such as a phone number, an actuatable user interface element for executing a verification procedure, and/or an actuatable user interface element, such as a keypad, for entering the unique identifier. The one or more Verification Interface(s) can include at least a third user interface having a user interface element for displaying a verification link message, a first actuatable user interface element for re-sending a verification link message, a second actuatable user interface element for changing the unique identifier, such as the phone number, and a third actuatable user interface element, such as a keypad, for entering the unique identifier. The one or more Verification Interface(s) can include at least a fourth user interface having a having a message thereon, including an executable link, such as a hyperlink, URL, URI, etc., for providing the Account Creation Interface.

In exemplary embodiments, the Account Creation Interface can include one or more fillable user interface element(s) for entering one or more account information, such as a user name, first name, last name, date of birth, unique identifier, such as a phone number, etc., and at least one actuatable user interface element for executing an account creation procedure.

In exemplary embodiments, the Subscription Interface can include a plurality of actuatable user interface element(s), each element being associated with a different subscription level. In embodiments, actuation of one of the plurality of actuatable user interface element(s) can begin execution of subscription procedure, wherein the user can be charged based on their subscription level. In the exemplary embodiment, the plurality of actuatable user interface element(s) include a first element for a free subscription level, i.e. a single user, a second element for paid subscription having a first number of subscribers, i.e. a two user subscription, and a third element for a paid subscription having a second number of subscribers, which is larger than the first number of subscribers, i.e. up to six users. Additionally, the paid subscription for the first number can be a lower amount than the paid subscription for the second number.

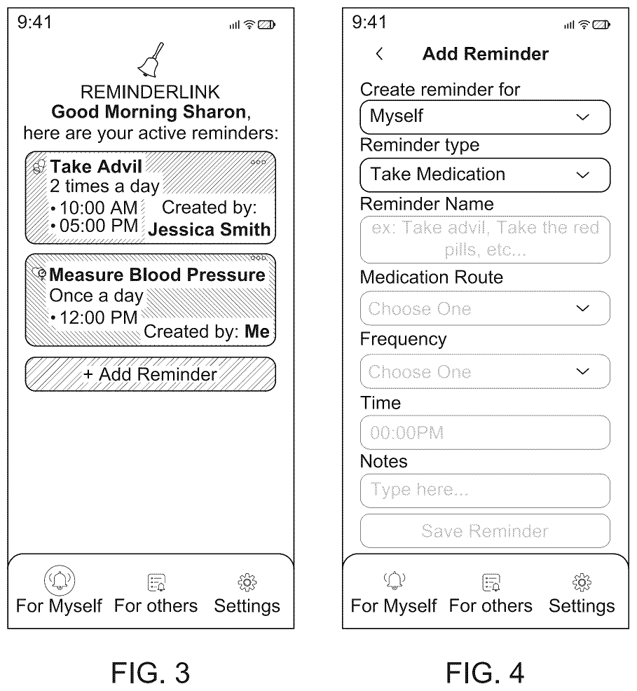

In exemplary embodiments, the one or more reminder Interface(s) can include interfaces for providing reminders to users, such as users 122 and 132. The one or more Reminder Interface(s) can include a home interface having one or more user interface elements, which can be actuatable, displaying one or more reminders for user(s), at least one actuatable user interface element for adding a reminder, and an actuatable user interface element, such as a menu, having at least three actuatable elements, including a first element for displaying one or more reminders created for the user by the user, a second element for displaying one or more reminders created for the user by another user, and a user interface element for accessing the one or more Settings Interface(s), as illustrated in FIGS. 3-8. In exemplary embodiments, the first element and second element can include one or more information items related to the one or more reminders.

In exemplary embodiments, the one or more Reminder Interface(s) can include at least one adaptive, or adaptable, user interface for adding a reminder having one or more user interface elements that change depending on one or more selection(s) of user(s), as illustrated in FIGS. 3-8. In exemplary embodiments, the at least one adaptive user interface can have at least a first actuatable user interface element, such as a list, for selecting a target of a reminder, such as myself, i.e. the current user, or someone else, i.e. an additional user. Upon selection of the first actuatable element, a second actuatable user interface element, such as a list, for selecting an additional user can be provided, if an additional user is selected in the first user interface element. In exemplary embodiments, the second actuatable user interface can be populated with additional user(s) selectable by the current user. Upon selection of the first actuatable element, a third actuatable user interface element, such as a list, for selecting a type of a reminder. In exemplary embodiments, the type of reminder list can include, but is not limited to reminders for taking medication(s), refilling prescription(s), Doctor/Medical Appointment(s), Other Appointment(s), Exercise, Hydration, Blood Sugar Check, Blood Pressure Monitoring, and/or other health or wellness reminders. In exemplary embodiments, upon selection using the third user interface element, a plurality of additional user actuatable and/or fillable user interface elements can be provided for the user to interact with based on the selection provided in the third user interface element.

In exemplary embodiments, if the type of reminder is to “take medication” a plurality of user interface elements can be provided to fill in information related to the reminder, such as, but not limited to: a reminder name, medication route, medication frequency, time to take medication and/or one or more additional notes. If the type of reminder is to “refill medication” a plurality of user interface elements can be provided to fill in information related to the reminder, such as, but not limited to: medication name, pharmacy, refill date, repeat, and/or an alert message text. If the type of reminder is “Doctor Appointment” a plurality of user interface elements can be provided to fill in information related to the reminder, such as, but not limited to: doctor name, date, time, repeat, and/or an alert message text. If the type of reminder is to “Other Appointment” a plurality of user interface elements can be provided to fill in information related to the reminder, such as, but not limited to: Title of Appointment, date, time, repeat, and/or an alert message text. If the type of reminder is to “Exercise” a plurality of user interface elements can be provided to fill in information related to the reminder, such as, but not limited to: Exercise type, details of exercise, i.e. sets and/or repetitions, time, repeat, and/or an alert message text. If the type of reminder is to “Hydrate” a plurality of user interface elements can be provided to fill in information related to the reminder, such as, but not limited to: Daily water goal, details, repeat, and/or an alert message text. If the type of reminder is to “Blood Sugar Check” a plurality of user interface elements can be provided to fill in information related to the reminder, such as, but not limited to: check time, details, repeat, and/or an alert message text. If the type of reminder is to “blood pressure monitor” a plurality of user interface elements can be provided to fill in information related to the reminder, such as, but not limited to: check time, details, repeat, and/or an alert message text. If the type of reminder is to “Other” a plurality of user interface elements can be provided to fill in information related to the reminder, such as, but not limited to: Reminder Title, details, date, time, repeat, and/or an alert message text. In exemplary embodiments, once all user interface elements are filled for a specified reminder, an actuatable user interface button to save the reminder can be provided.

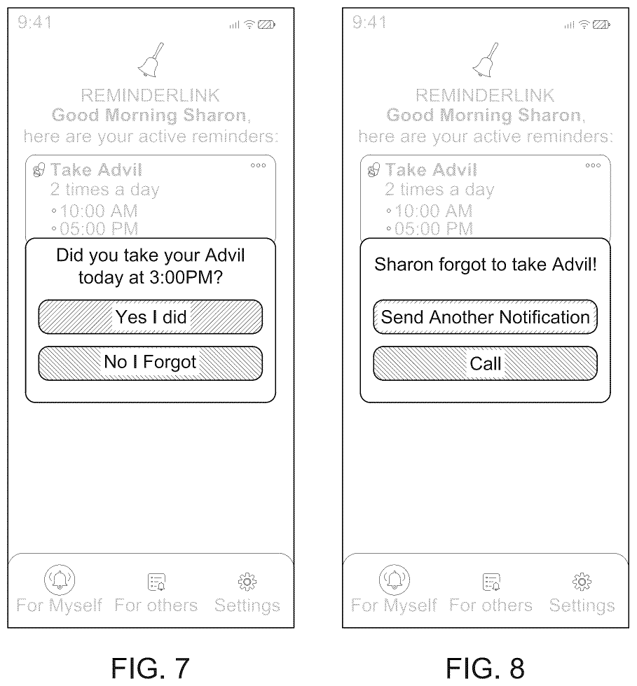

In exemplary embodiments, the one or more Notification Interface(s) can provide one or more notification user interface elements to notify user(s) of one or more reminders, as illustrated in FIGS. 7-8. In embodiments, the one or more notification interfaces can be GUI display elements on a home screen of devices 120 and/or 126. In exemplary embodiments, one or more actuatable user interface elements can be provided with the one or more Notification Interface(s), such that the user can verify that the reminder was accomplished, or not. Additionally, the one or more Notification Interface(s) can include one or more actuatable user interface element(s) to notify an additional user that the reminder was accomplished, or not, and one or more actuatable user interface elements to further interact with the user needing the reminder, such as a “send a reminder” button, or a “call” button.

In exemplary embodiments, one or more Contact Interface(s), can include one or more fillable and/or actuatable user interface elements to add a contact, such as a first name element, a last name element, a date of birth element, a phone number element, and/or an actuatable element to add the contact when all elements are filled.

In exemplary embodiments, one or more Settings Interface(s) can include one or more fillable, actuatable, or selectable user interface elements for viewing, editing, modifying, or otherwise interacting with one or more settings. In exemplary embodiments, an actuatable user interface element can be provided to change a phone number of a contact, and one or more selectable user interface elements can be provided to modify settings such as, allow/disallow notifications for completed reminders, allow/disallow notifications for uncompleted reminders, and/or allow/disallow notifications when an additional user sets-up a notification for the user.

In embodiments, the Interface module 140 can implement voice control aspects into the interfaces provided. For example, the user can navigate the interfaces of the ReminderLink system 102 using the audio input device of the caregiver device 120 or dependent device 126. The interface module 140 can implement one or more artificial intelligence and/or machine learning algorithms, e.g., chat-bots, to deliver conversational input and output to a user.

In embodiments ReminderLink module 142 can include a number of sub-modules, not limited to, an account maintenance sub-module 142-a, and a reminder sub-module 142-b. The account maintenance sub-module 142-a is configured to provide account login functionality, account creation functionality, account verification/validation functionality, account profile maintenance/creation functionality, user maintenance functionality, etc. The reminder sub-module 142-b is configured to provide reminder/notification maintenance, such as adding, deleting, modifying, or otherwise updating reminders and data associated with reminders. In embodiments, ReminderLink module 142 can provide data processing and/or event functionality underlying one or more interfaces provided by Interface module 140.

In embodiments, the application 124 and 128 can be a specifically designed application that operates with the ReminderLink system 102 to perform the processes and methods described herein. In embodiments, the application 124 and 128 can be a third-party application, such as a web browser, that communicates with the ReminderLink system 102 to perform the processes and methods described herein. The memory device 108 can also include one or more databases 114 that store information and data associated with the process and methods described below in further detail.

The processing device 104, the communication device 106, the memory device 108, and the I/O interface 110 can be interconnected via a system bus. The system bus can be and/or include a control bus, a data bus, and address bus, and so forth. The processing device 104 can be and/or include a processor, a microprocessor, a computer processing unit (“CPU”), a graphics processing unit (“GPU”), a neural processing unit, a physics processing unit, a digital signal processor, an image signal processor, a synergistic processing element, a field-programmable gate array (“FPGA”), a sound chip, a multi-core processor, and so forth. As used herein, “processor,” “processing component,” “processing device,” and/or “processing unit” can be used generically to refer to any or all of the aforementioned specific devices, elements, and/or features of the processing device. While FIG. 1 illustrates a single processing device 104, the ReminderLink system 102 can include multiple processing devices 104, whether the same type or different types.

The memory device 108 can be and/or include computerized storage medium capable of storing electronic data temporarily, semi-permanently, or permanently. The memory device 108 can be or include a computer processing unit register, a cache memory, a magnetic disk, an optical disk, a solid-state drive, and so forth. The memory device can be and/or include random access memory (“RAM”), read-only memory (“ROM”), static RAM, dynamic RAM, masked ROM, programmable ROM, erasable and programmable ROM, electrically erasable and programmable ROM, and so forth. As used herein, “memory,” “memory component,” “memory device,” and/or “memory unit” can be used generically to refer to any or all of the aforementioned specific devices, elements, and/or features of the memory device. While FIG. 1 illustrates a single memory device 108, the ReminderLink System 102 can include multiple memory devices 108, whether the same type or different types.

The communication device 104 enables the ReminderLink system 102 to communicate with other devices and systems. The communication device 104 can include, for example, a networking chip, one or more antennas, and/or one or more communication ports. The communication device 104 can generate radio frequency (RF) signals and transmit the RF signals via one or more of the antennas. The communication device 104 can generate electronic signals and transmit the RF signals via one or more of the communication ports. The communication device 104 can receive the RF signals from one or more of the communication ports. The electronic signals can be transmitted to and/or from a communication hardline by the communication ports. The communication device 104 can generate optical signals and transmit the optical signals to one or more of the communication ports. The communication device 104 can receive the optical signals and/or can generate one or more digital signals based on the optical signals. The optical signals can be transmitted to and/or received from a communication hardline by the communication port, and/or the optical signals can be transmitted and/or received across open space by the communication device 104.

The communication device 104 can include hardware and/or software for generating and communicating signals over a direct and/or indirect network communication link. As used herein, a direct link can include a link between two devices where information is communicated from one device to the other without passing through an intermediary. For example, the direct link can include a Bluetooth™ connection, a Zigbee connection, a Wifi Direct™ connection, a near-field communications (“NFC”) connection, an infrared connection, a wired universal serial bus (“USB”) connection, an ethernet cable connection, a fiber-optic connection, a firewire connection, a microwire connection, and so forth. In another example, the direct link can include a cable on a bus network. An indirect link can include a link between two or more devices where data can pass through an intermediary, such as a router, before being received by an intended recipient of the data. For example, the indirect link can include a WiFi connection where data is passed through a WiFi router, a cellular network connection where data is passed through a cellular network router, a wired network connection where devices are interconnected through hubs and/or routers, and so forth. The cellular network connection can be implemented according to one or more cellular network standards, including the global system for mobile communications (“GSM”) standard, a code division multiple access (“CDMA”) standard such as the universal mobile telecommunications standard, an orthogonal frequency division multiple access (“OFDMA”) standard such as the long term evolution (“LTE”) standard, and so forth.

The ReminderLink system 102 can communicate with one or more network resources via the network 116. The one or more network resources can include external databases, social media platforms, search engines, file servers, web servers, or any type of computerized resource that can communicate with the ReminderLink system 102 via the network 116.

As described above, the ReminderLink system 102 can include hardware components to perform the processes described herein. In embodiments, one or more of components, hardware, and/or functionality of the ReminderLink System 102 can be hosted and/or instantiated on a “cloud” or “cloud service.” As used herein, a “cloud” or “cloud service” can include a collection of computer resources that can be invoked to instantiate a virtual machine, application instance, process, data storage, or other resources for a limited or defined duration. The collection of resources supporting a cloud can include a set of computer hardware and software configured to deliver computing components needed to instantiate a virtual machine, application instance, process, data storage, or other resources. For example, one group of computer hardware and software can host and serve an operating system or components thereof to deliver to and instantiate a virtual machine. Another group of computer hardware and software can accept requests to host computing cycles or processor time, to supply a defined level of processing power for a virtual machine. A further group of computer hardware and software can host and serve applications to load on an instantiation of a virtual machine, such as an email client, a browser application, a messaging application, or other applications or software. Other types of computer hardware and software are possible.

In embodiments, the components and functionality of the ReminderLink system 102 can be and/or include a “server” device. The term server can refer to functionality of a device and/or an application operating on a device. The server device can include a physical server, a virtual server, and/or cloud server. For example, the server device can include one or more bare-metal servers such as single-tenant servers or multiple-tenant servers. In another example, the server device can include a bare metal server partitioned into two or more virtual servers. The virtual servers can include separate operating systems and/or applications from each other. In yet another example, the server device can include a virtual server distributed on a cluster of networked physical servers. The virtual servers can include an operating system and/or one or more applications installed on the virtual server and distributed across the cluster of networked physical servers. In yet another example, the server device can include more than one virtual server distributed across a cluster of networked physical servers.

Various aspects of the systems described herein can be referred to as “information,” “content,” and/or “data.” Content and/or data can be used to refer generically to modes of storing and/or conveying information. Accordingly, data can refer to textual entries in a table of a database. Content and/or data can refer to alphanumeric characters stored in a database. Content and/or data can refer to machine-readable code. Content and/or data can refer to images. Content and/or data can refer to audio and/or video. Content and/or data can refer to, more broadly, a sequence of one or more symbols. The symbols can be binary. Content and/or data can refer to a machine state that is computer-readable. Content and/or data can refer to human-readable text.

Various of the devices in the ReminderLink Environment 100, including the ReminderLink system 102 and/or the caregiver device 120 and/or dependent device 126 can provide I/O devices for outputting information in a format perceptible by a user and receiving input from the user. For example, the ReminderLink system 102 can communicate with the I/O devices via the I/O interface 110. The I/O devices can display graphical user interfaces (“GUIs”) generated by the ReminderLink system 102. The I/O devices can include a display screen such as a light-emitting diode (“LED”) display, an organic LED (“OLED”) display, an active-matrix OLED (“AMOLED”) display, a liquid crystal display (“LCD”), a thin-film transistor (“TFT”) LCD, a plasma display, a quantum dot (“QLED”) display, and so forth. The I/O devices can include an acoustic element such as a speaker, a microphone, and so forth. The I/O devices can include a button, a switch, a keyboard, a touch-sensitive surface, a touchscreen, a camera, a fingerprint scanner, and so forth. The touchscreen can include a resistive touchscreen, a capacitive touchscreen, and so forth.

FIG. 2 illustrates a method providing coordinated reminders, according to aspects of the present disclosure. While FIG. 2 illustrates various stages of the method 200, additional stages can be added, and existing stages can be removed and/or reordered. Briefly, and described in more detail below method 200 allows user 122 or 132 to create one or more reminders, for themselves, or for the other user 132 or 122. Once created the one or more reminders are provided to the appropriate user device 120 or 126, through application 124 or 128, respectively, and can notify the users of the reminder, and/or provide one or more notifications to the users of completed and/or missed reminders. In response to the one or more notifications, one or more additional actions can be provided to the users based on the outcome of the one or more notifications.

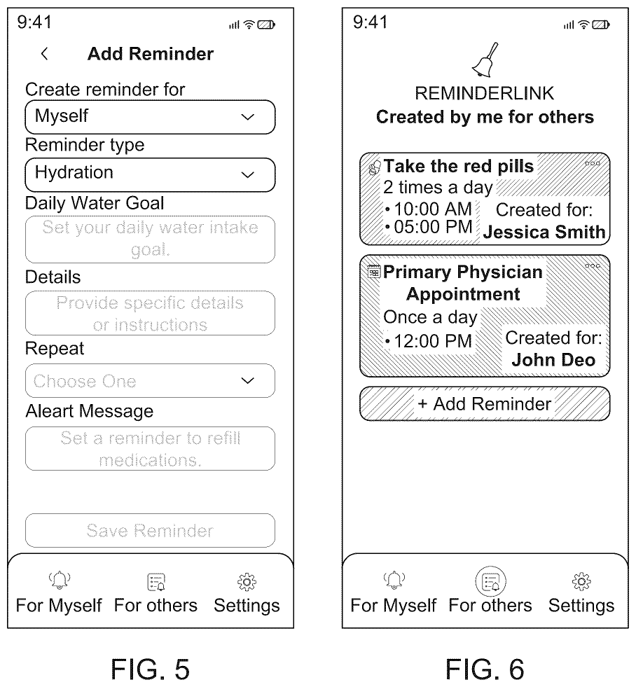

Method 200 can begin at step 202 where a request to create at least one reminder is received. The request can include information on the reminder including at least one user information, at least one temporal data, and at least one additional data. In embodiments, the at least one additional data can include a reminder type, which can trigger type dependent data to be filled in for the reminder, as illustrated in FIGS. 4-5. In embodiments, the reminder type can be, but is not limited to, reminders for taking medication(s), refilling prescription(s), Doctor/Medical Appointment(s), Other Appointment(s), Exercise, Hydration, Blood Sugar Check, Blood Pressure Monitoring, and/or other health or wellness reminders. In embodiments, type dependent data can include one or more of the following: a reminder name, medication route, medication frequency, time to take medication, doctor name, Title of Appointment, appointment date, appointment time, Exercise type, details of exercise, i.e. sets and/or repetitions, Dailey water goal, Hydration details, Blood Sugar check time, Blood Sugar details, Blood Pressure check time, Blood Pressure details, date, time, repeat, an alert message text, one or more additional notes, and/or any other information relevant to reminders as laid out with reference to Interface Module 140, above.

At step 204, in response to the at least one request, at least one reminder notification can be created. In embodiments, reminder notifications can be textual, graphical, and/or multimedia messages that can include the data provided in the at least one request, as illustrated in FIGS. 3 and 6. Reminder notifications are further described with respect to Interface Module 140, above.

At step 206, once a reminder is created, it can be transmitted to at least one user device, such as device 120 or 126. In embodiments, a reminder can be created for the creator, or for a 3^{rd} party, both of which can be indicated by the at least one user information provided in the at least one request. In embodiments, the at least one user information dictates how the reminder notification is distributed. For example, when the at least one user information indicates that the reminder is for the creator, the reminder can be sent to the creator's user device only, whereas when the reminder is for a 3^{rd} party, the reminder can be sent to the creator's user device and the 3^{rd} party's user device.

Finally, at step 208 an output can be triggered based on the at least one temporal data provided in the at least one request. In embodiments, the output can be a display of a notification, or reminder, that a task associated with the created reminder is due. In embodiments, the output triggered is dictated by the at least one user informed. For example, when the at least one user information indicates that the reminder is for the creator, and the reminder is on the creator's device, one or more notification can be provide to the creator's device to notify the user of an upcoming reminder, and/or provide one or more user interface elements for the user to interact with, such as an affirmation that the reminder was completed, or an affirmation that a reminder was not completed, as illustrate in FIG. 7. Further output can be provided based on the results of the affirmation. When the reminder is for a 3^{rd} party, the user device of the 3^{rd} party can receive one or more notifications of an upcoming reminder, and provide one or more user interface elements for the user to interact with, such as an affirmation that the reminder was completed, or an affirmation that a reminder was not completed, as illustrated in FIG. 7. In response to affirmation by the 3^{rd} party user, one or more additional outputs can be provided to the user who created the reminder, such as a notification that the 3^{rd} party did not complete the reminder, in response to an affirmation that the reminder was not completed. Additionally, in response to an incomplete reminder the user providing the reminder can be provided with one or more additional options to remind the 3^{rd} party, such as prompting a new reminder at the 3^{rd} party user's device, and/or calling the 3^{rd} party, as illustrate in FIG. 8. In response to an affirmation by the 3^{rd} party that the reminder was completed, an output can be provided to the user who created the reminder, that the reminder was completed.

As used in the description herein and throughout the claims that follow, “a”, “an”, and “the” include plural references unless the context clearly dictates otherwise. Also, as used in the description herein and throughout the claims that follow, the meaning of “in” includes “in” and “on” unless the context clearly dictates otherwise. While the above is a complete description of specific examples of the disclosure, additional examples are also possible. Thus, the above description should not be taken as limiting the scope of the disclosure which is defined by the appended claims along with their full scope of equivalents.

The foregoing disclosure encompasses multiple distinct examples with independent utility. While these examples have been disclosed in a particular form, the specific examples disclosed and illustrated above are not to be considered in a limiting sense as numerous variations are possible. The subject matter disclosed herein includes novel and non-obvious combinations and sub-combinations of the various elements, features, functions and/or properties disclosed above both explicitly and inherently. Where the disclosure or subsequently filed claims recite “a” element, “a first” element, or any such equivalent term, the disclosure or claims is to be understood to incorporate one or more such elements, neither requiring nor excluding two or more of such elements. As used herein regarding a list, “and” forms a group inclusive of all the listed elements. For example, an example described as including A, B, C, and D is an example that includes A, includes B, includes C, and also includes D. As used herein regarding a list, “or” forms a list of elements, any of which may be included. For example, an example described as including A, B, C, or D is an example that includes any of the elements A, B, C, and D. Unless otherwise stated, an example including a list of alternatively-inclusive elements does not preclude other examples that include various combinations of some or all of the alternatively-inclusive elements. An example described using a list of alternatively-inclusive elements includes at least one element of the listed elements. However, an example described using a list of alternatively-inclusive elements does not preclude another example that includes all of the listed elements. And, an example described using a list of alternatively-inclusive elements does not preclude another example that includes a combination of some of the listed elements. As used herein regarding a list, “and/or” forms a list of elements inclusive alone or in any combination. For example, an example described as including A, B, C, and/or D is an example that may include: A alone; A and B; A, B and C; A, B, C, and D; and so forth. The bounds of an “and/or” list are defined by the complete set of combinations and permutations for the list.

It should be understood, of course, that the foregoing relates to exemplary embodiments of the disclosure and that modifications can be made without departing from the spirit and scope of the disclosure as set forth in the following claims.

What is claimed is:

1. A system comprising:
one or more memory devices storing instructions;
one or more processors configured to execute the instructions to perform a method, the method comprising:
receiving at least one request to create a reminder, wherein the request includes at least: at least one user information, at least one temporal data, and at least one additional reminder data;
creating, based on the at least one request, at least one reminder notification;
transmitting, based on the at least one user information, the at least one reminder notification to at least one user device;
triggering, based on the at least one temporal information, output of the at least one reminder notification to the at least one user device.

2. A computer implemented method for health reminders, comprising:
receiving at least one request to create a reminder, wherein the request includes at least:
at least one user information, at least one temporal data, and at least one additional reminder data;
creating, based on the at least one request, at least one reminder notification;
transmitting, based on the at least one user information, the at least one reminder notification to at least one user device;
triggering, based on the at least one temporal information, output of the at least one reminder notification to the at least one user device; and
outputting the at least one reminder notification to the at least one user device.

3. The method of claim 2, further comprising:
in response to at least one interaction, with the at least one reminder notification, display at least one additional notification at the at least one user device.

4. The computer implemented method of claim 3, wherein the at least one additional notification is displayed to the at least one user device, based on the at least one user information.

5. The computer implemented method of claim 2, wherein the least one user information is an indicator that the reminder is one of: a personal reminder, or a third-party reminder.

6. The computer implemented method of claim 5, wherein the transmitting further comprises:
in response to the user information being a personal reminder, transmitting the at least one reminder notification to a first user device; and
in response to the user information being a third-party reminder, transmitting the at least one reminder notification to a second user device, different from the first user device.
